(19) United States
(12) Patent Application Publication
(10) Pub. No.: US 2008/0105267 A1
(43) Pub. Date: May 8, 2008

(54) Protection assembly for syringe

(75) Inventor: Sabrina Saurou, Paris (FR)

Correspondence Address: YOUNG & THOMPSON, 209 Madison Street, Suite 500, ALEXANDRIA, VA, 22314, US

(73) Assignee: ZONE INDUTRIELLE DU PHARE, MERIGNAC (FR)

(21) Appl. No.: 11/856,117

(22) Filed: Sep. 17, 2007

(30) Foreign Application Priority Data
Nov. 3, 2006 (FR) 06/09614

(51) Int. Cl. A61C 19/02

(52) U.S. Cl. 128/846; 433/229; 433/25; 433/80

(57) ABSTRACT

A protection assembly for a syringe, in dentistry in particular, that includes a syringe body, with the protection assembly being of the disposable type and including:
a canula (10) in an elastically rigid material, including a base that is intended (16) to be fixed onto the syringe body,
and a sheath (12) in a flexible material formed of two parallel plane walls (18A, 18B) intended to loosely cover the syringe body,
the sheath being fixed onto the canula close to the base, and the fixation being of the irreversible type.

### AREA OF THE INVENTION

This present invention concerns a protection assembly for a syringe.

By syringe is meant any appliance used in particular in dentistry to spray a fluid at high pressure, such as air and/or water for example, on a treated dental zone.

### BACKGROUND OF THE INVENTION

It is known that precautions must be taken in order to prevent a syringe from being contaminated by a patient or contaminating a patient with a contagious illness, in particular by the diffusion of viruses such as those of hepatitis or AIDS.

One way of guarding against such contamination consists of possibly sterilising the syringe before each use. This measure is not always however, given of the size or the geometry of the syringes. Thus, another way of guarding against contamination consists of using a dispensable protection assembly.

FIG. 1 shows a protection assembly for a syringe according to document U.S. Pat. No. 4,998,880.

This protection assembly includes a dispensable canula with a base (4) that is intended to be fixed onto on a syringe, generally by means of an adapter. The protection assembly also includes a sheath (6) formed from a flexible film rolled on itself close to the base 4. To use this protection assembly, the practitioner fixes the canula (2) onto a syringe and unrolls the sheath (6), which will then cover the syringe body. The applicant observed that this protection assembly was not of great practical use. Firstly, the storage of a multiplicity of protection assemblies is rendered difficult by the fact that the unrolled sheaths have a tendency to stick to each other. Secondly, the fitting of the sheath onto the body of the syringe is awkward, with the practitioner holding the syringe body with one hand, and then having only one hand to unroll the sheath.

This means that the protection assembly according to the prior art is not satisfactory for the practitioner.

The aim of the invention is to overcome the drawbacks of the known protection.

### SUMMARY OF THE INVENTION

To this end, the subject of the invention is a protection assembly for a syringe, in particular in dentistry, that includes a syringe body, with the said protection assembly being of the disposable type and including:
a canula in an elastically rigid material with a base that is intended to be fixed onto the syringe body,
and a sheath in a flexible material formed from two parallel plane walls intended to loosely cover the said syringe body,

with the said sheath being fixed onto the said canula, close to the said base, and the said fixing method being of the irreversible type. By irreversible fixing is meant that the sheath and the canula cannot be separated from each other, except by destroying the protection assembly irremediably.

According to a preferred method of implementation, at its end opposite to that fixed onto the canula, the sheath has a zone that is formed by a tear line.

Advantageously, the said zone is equipped with an orifice.

### BRIEF DESCRIPTION OF THE DRAWINGS

Other characteristics and advantages of the invention will appear on reading the description that follows of one method of implementation, provided by way of illustration but not limiting, and with reference to the appended drawings, in which:

FIG. 1, already described, illustrates a protection assembly for a syringe according to the prior art,

FIG. 2 illustrates a protection assembly for a syringe according to the invention, and

FIG. 3 illustrates the protection assembly of FIG. 2 after it has been fitted to a syringe.

### DETAILED DESCRIPTION OF THE INVENTION

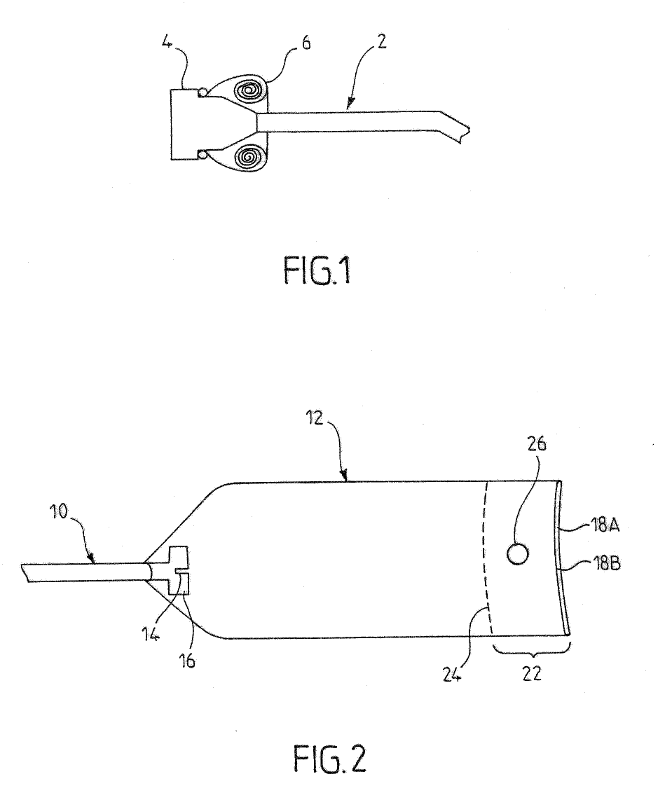

FIG. 2 shows one method of implementation of a protection assembly according to the invention. This protection assembly includes a canula (10) and a sheath (12).

The canula (10) is of general cylindrical shape, and in particular its section can be circular, elliptical, rectangular, etc. Its has two channels (not shown) that are intended for the spraying of fluids such as air and water for example, when the canula is in position on the end of a syringe body. To this end, the canula (10) has a reference mark (14) to facilitate the orientation of its channels by the practitioner in relation to those of the syringe. The canula also has a base (16) to allow it to be secured, by friction fit, for example, on the syringe body.

The canula is created from an elastically deformable material, so that the practitioner can bend it and orientate it as required in relation to the area of the mouth to be treated. The material of the canula is preferably a polymer and, for example, a high-density polyethylene such as PE HD ERACLENE MR80, the density of which is of the order of 0.954 g/cm³. Typically, the cross section of the canula covers an area of the order of 2 to 10 mm^{z}.

The sheath (12) is intended to receive the body of a syringe or at least a good portion of the latter.

Before it is installed by the practitioner, it takes the form of a flexible film formed of two plane walls (18A, 18B). It has one end that is fixed onto the canula (10) close to its base (16). This fixing can be achieved using any known means and in particular by adhesives, ultrasound welding, etc.

The sheath (12) is formed from a flexible material, such as a polymer, and comes in the form of a thin film. By way of an example, it is possible to choose a polyethylene with a density of 0.905 g/cm³, in the form of a film with a thickness of 0.1 mm.

The sheath (12), for example, has a length of the order of 25 cm and a width of the order of 6 cm. This width is chosen so that the syringe body can be inserted easily, that is without rubbing, into the sheath between the two walls 18A and 18B.

As shown in FIG. 2, the end of the sheath opposite to the canula (10) can include a zone (22) formed by a tear line (24). This zone (22), the length of which is 3 cm for example, can include an orifice (26).

The flat shape of the sheath before it is positioned on a syringe allows optimal storage of the protection assembly. Moreover, when the sheath is equipped with a tear line (24) and an orifice (26), then a large number of protection assemblies can be stored alongside each other for example, suspended by their orifices (26) on a single axis. A practitioner can thus easily take a protection assembly by pulling on the canula so as to tear the sheath along the tear line (24).

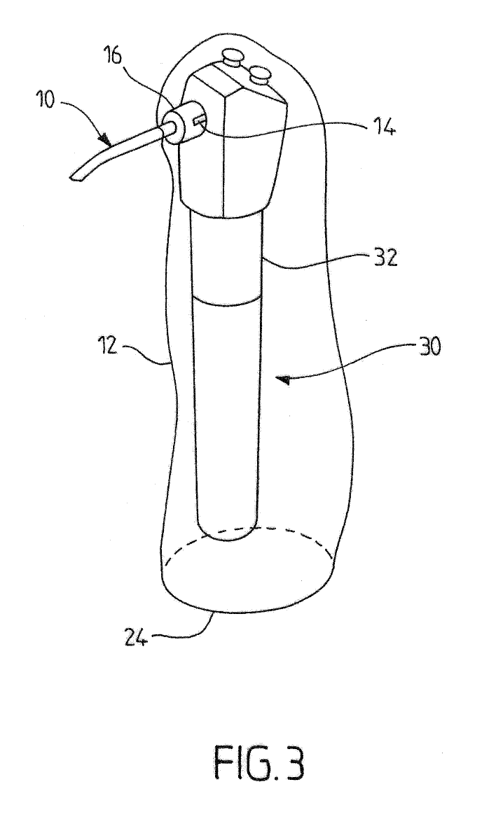

FIG. 3 shows a protection assembly in position on a syringe. In this figure, the elements identical to those of FIG. 2 bear the same numerical references.

The base (16) of the canula (10) is fitted to an adapter of the syringe body. This canula is deformed elastically by the practitioner so that it is able to reach the zone to be treated.

In the method of implementation represented, the syringe body is fully contained within the sheath (12), whose walls practitioner has opened out in order to allow the introduction of the syringe body. The width of the sheath is chosen to be sufficient so that a conventional syringe can be inserted easily into the sheath, meaning without any friction.

It can be seen that such a protection assembly is easier to fit onto a syringe than the protection assemblies according to the prior art. Likewise, when it is desired to use the syringe, it is particularly easy to remove the protection assembly from the syringe.

The protection assembly according to the invention allows efficient storage, and is particularly simple for the practitioner to use. In addition, being dispensable, it prevents contamination of the syringe.

1. A protection assembly for a syringe (30), in dentistry in particular, that includes a syringe body (32), with the said protection assembly being of the disposable type and being characterised in that it includes:
a canula (10) in an elastically rigid material that includes a base (16) intended to be fixed onto the syringe body,
and a sheath (12) in a flexible material, formed of two parallel plane walls (18A, 18B) intended to cover the said syringe body loosely, the said sheath being fixed onto the said canula close to the said base, and the said fixing being of the irreversible type.

2. A protection assembly according to claim 1, characterised in that, at its end opposite to that fixed onto the canula, the sheath (12) presents a zone (22) formed by a tear line (24).

3. A protection assembly according to claim 2, characterised in that it includes an orifice (26) in the said zone (22).
